(19) United States
(12) Patent Application Publication
(10) Pub. No.: US 2004/0139585 A1
(43) Pub. Date: Jul. 22, 2004

(54) Fastening kit and injection molded fastening article for use in such a kit

(76) Inventor: Henry J. McVicker, Naples, FL (US)

Correspondence Address: JONES DAY, 77 WEST WACKER, CHICAGO, IL, 60601-1692, US

(21) Appl. No.: 10/745,353

(22) Filed: Dec. 23, 2003

Related U.S. Application Data
(60) Provisional application No. 60/436,028, filed on Dec. 23, 2002.

(51) Int. Cl. B32B 3/06

(52) U.S. Cl. 24/442; 428/100

(57) ABSTRACT

A fastening kit comprises an injection molded pallet having a field of integrally molded hooks on a surface, and a cooperative loop-bearing member. When the pallet is fastened to a first object and the cooperative loop bearing member is attached to a second object, the first and second objects can be releasably attached to one another by contacting the loops of the loop bearing member with the field of integrally molded hooks.

This application claims the benefit of provisional patent application Serial No. 60/436,028, filed Dec. 23, 2002, under 35 U.S.C. § 119.

### BACKGROUND OF THE INVENTION

This invention relates to a fastening kit comprising an injection molded hook member, and to an injection molded article for use in a fastening system with a cooperative loop bearing member.

Fastening elements are known in the prior art in a variety of different formats, including releasable fastening systems such as snaps, buttons, and hooks, and non-releasable fastening systems such as rivets, screws and nails. One releasable fastening system, originated by the Velcro Company, uses mating surfaces of hooks and loops. In a Velcro-type system, one flexible ribbon is provided with a field of tiny flexible hooks on one surface thereof, and a mating flexible ribbon is provided with a field of loops on one surface thereof. The hook-bearing ribbon and the loop-bearing ribbon are attached to surfaces of objects to be fastened together. The objects can be releasably attached to one another by pressing the hook-bearing surface on one object and the loop-bearing surface on the other object against each other, such that the hooks and the loops releasably engage one another. The hook- and loop-bearing ribbons can be sewn to fabric, or can be glued to rigid surfaces.

Ribbon-backed hook and loop type fasteners are used in a variety of manufactured articles, including apparel, sport pads, back packs, and the like. Also commercially available are kits including ribbons of adhesive-backed hook material and ribbons of adhesive-backed loop material. The purchaser of the kit can apply cooperating strips of hook and loop materials to the surfaces of any objects such that the objects can be releasably fastened together.

U.S. Pat. No. 5,368,549, U.S. Pat. No. 5,656,226, and U.S. Re. 37,338, each of which is incorporated herein by reference in its entirety, disclose an injection molded article having a field of injection molded hooks integrally molded into one substantially rigid wall of the article, and a method of making such an injection molded article with a field of integrally molded hooks. In the embodiment disclosed in those patents, the article is an orthopedic ankle brace, which is fastened about the ankle of a user by means of a loop-bearing strap that is attached to one portion of the brace and releasably attaches to the injection molded field of hooks.

EPO 0 464 755 assigned to YKK company discloses a fastening element having rows of hooks on one side that is used to retain a fabric covering against the inside surface of a car roof, and a fastening clip molded to the opposite side to hold the fastening element in place.

U.S. Pat. No. 5,488,750 discloses a sponge mop attachment including an integral unitary body which also consists of an attachment surface, “which could be Velcro™ or similar material.”

U.S. Pat. No. 5,615,461 of YKK Co. discloses a fastening element for supporting draperies, the fastening element comprising a substantially flat molded article having rows of hooks molded on one side adapted to engage a field of loops, and a single large hook formed on one end of the fastener for hanging the fastener on a curtain rod or the like.

A fastening element bearing the marks “Racemark” and Mat-Loc” is a flat disc, on one surface of which are rows of hook elements apparently intended to engage loops on a loop bearing member, and on the opposite surface of which is a screw-like projection, apparently intended to mount the fastener in an object.

It is an object of the invention to provide a fastening kit, and an injection molded hook-bearing component of a hook and loop type fastening system that can be used in the fastening kit in a variety of different applications according to the needs of the user.

### SUMMARY OF THE INVENTION

The instant invention is a fastening kit and an injection molded article for use in a fastening kit, the article comprising an injection molded wall having a field of injection molded hooks formed on a portion thereof. The injection molded article is suitable for attachment to an object to which another object having a cooperative loop-bearing member is to be attached. The injection molded article is in the form of a substantially flat pallet of any desired shape, the pallet having on at least one surface thereof an integrally molded field of hooks, the pallet further comprising means for attaching the pallet to a desired object. For example, the pallet can be provided with holes to receive nails, tacks, screws or other attachment means, or the back surface of the pallet can be provided with an adhesive. The kit preferably also includes one or more strips or patches of loop bearing material to be applied to objects to be fastened to the field of hooks.

### DESCRIPTION OF THE FIGURES

FIG. 1a is a front elevation view of an injection molded fastening element having a field of hooks thereon.

FIG. 1b is a side elevation view of the injection molded fastening element taken through line 1b.-1b. of FIG. 1a.

### DETAILED DESCRIPTION OF THE INVENTION

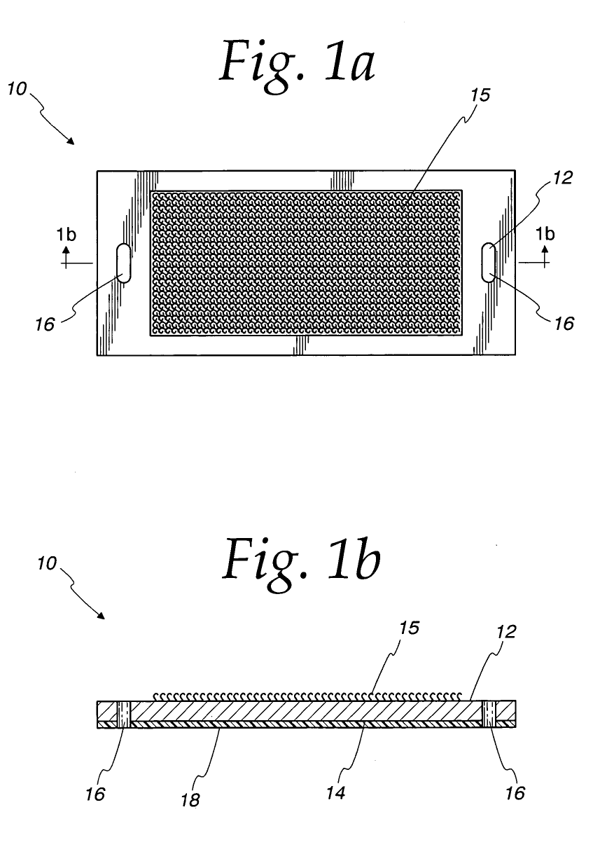

FIGS. 1a and 1b illustrate an injection molded fastening element having a field of hooks thereon such as is suitable for use as a component of a hook and loop fastening system. Pallet 10 is an injection molded article having an outwardly facing fastening surface and a rearwardly facing mounting surface 14. Disposed on a portion of outwardly facing fastening surface 12 is a field of hooks 15. Field of hooks 15 can be of any desired shape and size. The hooks can be single tipped hooks or double tipped hooks. The hooks can be facing all in one direction, or in alternating directions, or in any arrangement of directions that meets the needs of a particular application.

Pallet 10 is provided with means for mounting to another surface. The means can be in the form of holes or slots 16, which can receive nails, screws, tacks, and the like, such that pallet 10 can be mounted with its mounting surface 14 against a wall or other structure capable of receiving the end of a nail, screw, tack, or the like. Mounting surface 14 also can be provided with a layer of adhesive 18. Adhesive layer 18 can be provided with a release liner, not shown, as is well-known in the art of adhesive-backed articles.

In a preferred embodiment, the pallet 10 is a component of a fastening kit, which kit also includes at least one cooperative loop-bearing member such as is known in the art. The loop bearing member will have a field of loops, and a means for mounting the loop bearing member on an object to be fastened to the object to which pallet 10 is mounted. The loop bearing member can be in the form of an adhesive backed loop bearing ribbon or patch of fabric. Alternatively, if the object to which the loop bearing member is to be attached can be stitched, such as fabric or stitchable plastic, then the loop bearing member can be stitched to that object.

In a preferred embodiment, injection molded pallet 10 has a field of flexible hooks 15 integrally formed on a portion thereof. The pallet 10 with field of flexible hooks 15 can be made in accordance with the methods disclosed in the aforementioned U.S. Pat. No. 5,368,549, U.S. Pat. No. 5,656,226, and U.S. Re. 37,338. As disclosed therein, the hooks of the injection molded article will have a radius and geometry that will promote the ejection of the hooks from the injection mold, while still maintaining the desired fastening function. The hooks will straighten momentarily as they are removed from the injection mold. Pallet 10 is molded from a thermoplastic material that has sufficient flexibility to allow the hooks to straighten during removal from the mold and during subsequent release form a field of loops, yet has a memory sufficient to return to substantially the original hook shape and geometry. A material that is too rigid or brittle would snap off during such flexing. On the other hand, a material that is too soft would lack the structural rigidity required for the hooks to function as a fastener. Suitable thermoplastic materials include polypropylene and polyurethane materials having the desired balance of flexibility and shape memory. The polypropylene can be, for example, an unfilled polyester blend of 50% homopolymer and 50% copolymer having a melt flow index of 22 g/10 min. and a flex modulus from 130,000 to 150,000 psi. Another suitable polypropylene material is sold by Washington Penn Plastic Company of Washington, Pa. as product PPC3CF1, having a melt flow index of 11.6 g/10 min.; a notched Izod impact strength of 3.1 ft-lbs./in., a tensile strength of 3000 psi, and a flex modulus of 163,300 psi.

Other propylene based resins that have been found suitable for use in forming molded hooks include Atofina polypropylene PPC 5660, having a melt flow index of 7, and a flex modulus of about 175,000 psi; various resins sold under the name “Pro-fax” by Basell, and having melt flow index values ranging from 18 to 35 and flex modulus values ranging from 150,000 to 200,000 psi; propylene copolymers sold by BP Amoco under the names Acclear® 8949 and Acctuf® impact copolymer 3934X, having melt flow index values of 35 and 100, and flex modulus values of 190,000 psi and 250,000 psi, respectively; resins sold by Dow Plastics under the names Inspire C703-35U and Inspire C719-35RN HP, both having a melt flow index of 35, and flex modulus values of 180,000 psi and 160,000 psi, respectively; Exxtral® BMT 106 polypropylene impact copolymer, sold by ExxonMobil Chemical, having a melt index of 8 and flex modulus of about 218,000 psi; and, long glass fiber reinforced polypropylenes sold by StaMax, resin 30YM240/10010 having a flex modulus of about 856,000 psi, and resin 40YM240/10010 having a flex modulus of about 1,140,000 psi. With long glass fiber reinforced polypropylenes having very high flex modulus values, it is believed that the glass fibers do not migrate into the hook cavities of the mold, so that the integrally molded hooks are made up of only the polypropylene component of the resin. This gives the unexpected result of a field of flexible hooks integrally molded on a surface of a very strong, rigid molded object.

Resins other than propylene based resins also can be suitable for use in the manufacture of the molded integral hooks of the present invention. Such resins can include high impact polystyrene, acrylonitrile-butadiene-styrene, nylon, high density polyethylene, linear low density polyethylene, polycarbonate, and thermoplastic olefin resins. Melt index has been found to range from 1 to 100, and flex modulus values values have been found to range from under 30,000 to over 1,138,000. The melt index values and flex modulus values that will work depend on the particular resin chosen. Specific resins include high impact polystyrene API 550 from American Polymers, having a melt flow index of 8 and a flex modulus of 280,000 psi; acrylonitrile-butadiene-styrene, including ABS 9501 UHI from Diamond Polymers, having a melt flow index of 1 and a flex modulus of about 295,000 psi, and Starex ABS SD-0150, sold by Samsung, and having a flex modulus of 420,000 psi; nylon, including Akulon® K224-PG2U Nylon 6, sold by DSM Engineering and having a flex modulus of about 580,000 psi, and Celanese nylon 6/6 1000 sold by Ticona, and having a flex modulus of about 420,000; high density polyethylene Alathon® H 5618, sold by Equistar Chemicals having a melt flow index of 18; linear low density polyethylene Petrothene® GA 564-000 sold by Equistar Chemicals and having a melt flow index of 21; polycarbonate Lexan ML4991R sold by General Electric, having a melt flow index of about 300,000; and thermoplastic olefin polymer Ecobarrier 1B00-2614 TP, having a melt index of 4 and a flex modulus of about 26,000. For polymers having such low flex modulus values, it may be necessary or desirable to use a thicker hook shape to provide a hook that is stiff enough and strong enough to provide the desired closure properties.

In addition, pallet 10 can be relatively rigid, or, it can be injection molded to be thin enough such that it is sufficiently flexible to be mounted to curved surfaces. This can be accomplished, for example, by molding pallet 10 such that the pallet is thinner at its edges than in the center where the field of hooks is supported.

As further disclosed in the aforementioned patents, an apparatus for making the injection molded articles comprises a mold for forming the pallet 10, the mold having a recess in at least one predetermined area thereof, and means in the recess for simultaneously and integrally forming a field of injection molded hooks during the injection molding of the pallet. The field of hooks has a length and a width, the hooks being interspersed in both the length and width of the field. The means in the recess for forming the hooks has a plurality of hook shaped cavities. The means is in unitary assembly during the injection molding of the device, and is maintained in unitary assembly during the removal of the injection molded pallet 10 therefrom. In a preferred embodiment, the means in the recess for forming the hooks during the injection molding process is an assembly of stacked plates, each plate having a plurality of hook shaped cavities formed in one edge thereof. In a most preferred embodiment, the plates alternate in the stack with plates called spacers, which have no hook shaped cavities. The spacer plates can have width less than, equal to, or greater than the plates with the hook shaped cavities.

While the pallet 10 has been illustrated in which the fastening elements all have been in the form of injection molded hooks, the invention is not so limited. The fastening elements also can be in the form of mushroom shaped fastening elements, palm tree shaped fastening elements, or cane shaped hooks but either stiffer or of a different shape than those described in the aforementioned U.S. Pat. No. 5,368,549, U.S. Pat. No. 5,656,226, and U.S. Re. 37,338. In such embodiments, the means for forming the field of fastening elements may require the use of plates that move with respect to one another during the unmolding of the pallet 10 to avoid breaking the fastening elements.

While the foregoing specification and drawings describe only the embodiments of the invention shown and described, other embodiments of the invention can be articulated as well, and such embodiments and their equivalents are to be considered within the scope of this invention.

What is claimed is:

1. An injection molded pallet for use as a component of a fastening kit, said pallet comprising a wall member having a first surface with a field of integrally molded hooks formed on a portion of said first surface, said field of hooks being releasably engageable by a cooperative loop-bearing member, said pallet further comprising means for mounting said pallet to an object.

2. The injection molded pallet of claim 1 wherein said mounting means comprises one or more apertures through said pallet, said one or more apertures being sized and dimensioned to accommodate a fastening member.

3. The injection molded pallet of claim 2 wherein said fastening member is selected from the group consisting of nails, screws, and tacks.

4. The injection molded pallet of claim 1 wherein said wall member of said pallet comprises a second surface opposite said first surface having said field of injection molded hooks, and said mounting means comprises a layer of adhesive on said second surface.

5. The injection molded pallet of claim 4 further comprising a release liner disposed over said adhesive layer.

6. The injection molded pallet of claim 1 wherein said wall member further comprises a region without said field of hooks, said region being of a thickness less than the thickness of the wall at said surface of said field of hooks, said region being conformable to a curved surface.

7. The injection molded pallet of claim 1 wherein said hooks are flexible and said polymer is made from a polymer material with memory such that the hooks straighten as they are removed from the injection mold in which they are formed and resume substantially their original hook shape.

8. The injection molded pallet of claim 7 wherein said polymer is selected from the group consisting of polypropylene, polypropylene copolymers, glass fiber reinforced polypropylene, high density polyethylene, linear low density polyethylene, polycarbonate, thermoplastic olefin polymer, nylon, high impact polystyrene and acrylonitrile-butadiene-styrene

9. A fastening kit for use in releasably fastening a first object to a second object, said kit comprising
an injection molded pallet, said pallet comprising a wall member having a first surface with a field of integrally molded hooks formed on a portion of said first surface, said field of hooks being releasably engageable by a cooperative loop-bearing member, said pallet further comprising means for mounting said pallet to a first object, and
a cooperative loop-bearing member for attachment to a second object, whereby when said pallet is attached to said first object and said loop-bearing member is attached to said second object, said first and second objects can be releasably attached to one another by contacting said loop-bearing member with said field of injection molded hooks.

10. The fastening kit of claim 9 wherein said pallet mounting means comprises one or more apertures through said pallet, said one or more apertures being sized and dimensioned to accommodate a fastening member.

11. The fastening kit of claim 10 wherein said fastening member is selected from the group consisting of nails, screws, and tacks.

12. The fastening kit of claim 9 wherein said pallet comprises a second surface opposite said first surface having said field of injection molded hooks and said mounting means comprises a layer of adhesive on said opposite surface.

13. The fastening kit of claim 12 further comprising a release liner disposed over said adhesive layer.

14. The injection molded pallet of claim 8 wherein said wall member further comprises a region without said field of hooks, said region being of a thickness less than the thickness of the wall at said surface of said field of hooks, said region being conformable to a curved surface.

15. The injection molded pallet of claim 8 wherein said hooks are flexible and said polymer is made from a polymer material with memory such that the hooks straighten as they are removed from the injection mold in which they are formed and resume substantially their original hook shape.

16. The injection molded pallet of claim 15 wherein said polymer is selected from the group consisting of polypropylene, polypropylene copolymers, glass fiber reinforced polypropylene high density polyethylene, linear low density polyethylene, polycarbonate, thermoplastic olefin polymer, nylon, high impact polystyrene and acrylonitrile-butadiene-styrene
